(19) United States
(12) Patent Application Publication
(10) Pub. No.: US 2023/0001337 A1
(43) Pub. Date: Jan. 5, 2023

(54) RECESS FOR RECEIVING A FILTER CARTRIDGE

(71) Applicant: ActBlue Europe S.a r.l., Senningerberg (LU)

(72) Inventors: Diouf CHEIKH, Toulouse (FR); Romain JACQUES, Toulouse (FR)

(21) Appl. No.: 17/776,971

(22) PCT Filed: Nov. 10, 2020
(86) PCT No.: PCT/EP2020/081573

§ 371 Date: May 13, 2022

(30) Foreign Application Priority Data
Nov. 14, 2019 (FR) FR1912689

(51) Int. Cl. B01D 35/30; B01D 53/94; B01D 29/11; B01D 35/18

(52) U.S. Cl. CPC B01D 35/30; B01D 53/9418; B01D 29/114; B01D 35/18; B01D 2201/4092; B01D 2201/302; B01D 2201/347

(57) ABSTRACT

An axial extension part is proposed which makes it possible to use a filter cartridge (25) of larger axial dimensions than a standard filter cartridge for which the axial depth of a hollow housing (11) of a casing (10) of a selective catalytic reduction (SCR) device has been provided. This makes it possible to have different filtration characteristics without having to modify the casing. The larger filter cartridge (25) can be inserted into the extension part when this part is mounted in the housing (11) of the casing (10). The cartridge is sealed therein when the sealing cap (21) is put in place to close the opening at the rear end of the part.

### TECHNICAL FIELD

The present invention relates in general to the distribution of liquid additive used for example in a device for treating the exhaust gases of a motor vehicle, such as a device for treatment by selective catalytic reduction (SCR), and more particularly to an axial extension part of a hollow housing in a casing of such a device, intended to receive a filter cartridge.

The invention has application, in particular, in motor vehicles, specifically but not exclusively those equipped with a diesel engine, for example in light vehicles, utility vehicles or lorries (or heavy goods vehicles) comprising such an engine.

### PRIOR ART

The exhaust gases generated by vehicles with compression ignition engines (known as diesel engines) or by vehicles with spark ignition engines (known as petrol engines), consist in particular of gaseous atmospheric pollutants such as carbon oxides (called “COx”, for CO and CO2) and nitrogen oxides (called “NOx” for NO and NO2). Diesel engines, in particular, are regulated to reduce the amount of polluting gases they emit. The standards limiting the levels of nitrogen oxides emitted are an example of this, and tend to be increasingly restrictive.

In the particular case of vehicles fitted with a diesel engine, the depollution of the engine exhaust gases can be carried out by means of a gas treatment device implementing a depollution method such as the selective catalytic reduction method (or SCR method). The SCR method uses a liquid depolluting additive to selectively reduce the nitrogen oxides (NOx) contained in the exhaust gases. Depolluting liquid additive means a depolluting product which can be injected into an exhaust gas treatment device of an engine for the purpose of depolluting the exhaust gases before they are discharged into the atmosphere.

The liquid additive commonly used in the SCR method is a diesel exhaust fluid (DEF) which is an aqueous solution of urea at 32.5% (by weight), also marketed under the AdBlue® brand. The aqueous solution of urea is a precursor of ammonia (NH3). This ammonia reacts with the nitrogen oxides (NOx) of the exhaust gases to produce less polluting species, namely dinitrogen (N2), water, and carbon dioxide (CO2). Thus, the ammonia used in the SCR method is a reducing agent, supplied as a liquid additive.

In vehicles, the liquid additive is stored in a dedicated reservoir, which is equipped with a metering module also called a liquid additive dispensing device. The liquid additive dispensing device is suitable for withdrawing the liquid additive, metering a determined amount thereof and injecting it into the exhaust gas treatment device with a view to depolluting said gases. For this, the liquid additive dispensing device comprises a casing in which are arranged functional components such as in particular means for pumping, for filtering and/or for metering the liquid additive, means for measuring the amount of liquid additive present in the reservoir, sensors such as a temperature sensor for the liquid additive present in the tank, means for heating the liquid additive adapted to thaw it if necessary, etc.

This dedicated tank represents additional bulk for the vehicle. Thus, advantageously, the metering module can be placed inside the liquid additive reservoir so that its casing occupies part of the space in the reservoir.

Documents DE 102006040411A1 and DE 102012003156A1 disclose filter cartridges for SCR devices. Such filter cartridges are generally removable, so that they can be replaced during the lifetime of the SCR device.

It appears that it is desirable to be able to use filter cartridges offering different filtration capacities without the need, however, to modify the design of an existing metering module. Indeed, depending on the vehicle, certain applications require the use of a filter having, for example, better dust-holding capacity and/or a lower pressure drop than other applications. Obtaining such improved characteristics may require the use of a larger filter cartridge than a cartridge of standard dimensions for which a metering module may have been designed.

A technical problem which then arises is the lack of flexibility of the filtration capacities for a given metering module, having a casing with specific dimensions and shapes.

### DISCLOSURE OF THE INVENTION

The invention aims to eliminate, or at least attenuate, all or part of the aforementioned drawbacks of the prior art.

To this end, a first aspect of the invention proposes an extension part of a hollow housing provided in a casing to receive a first filter cartridge, said housing extending along a specific longitudinal axis between a first axial end and a second opposite axial end, and having an opening at the first axial end for inserting said first filter cartridge into the housing parallel to the direction of the longitudinal axis of the housing, and a bottom at the second axial end, said housing having a specific axial depth, between said opening and said bottom, and having at least one circumferential wall extending substantially parallel to said direction and forming an envelope of a specific shape, said extension part having a longitudinal axis and comprising:

a) a first axial end by which the part can be inserted into the housing of the casing, and a second axial end provided with an opening through which a second filter cartridge, of greater axial length than the axial depth of the housing, can be inserted and sealed in the part when said part is mounted in the housing of the casing;

b) a first axial section of substantially equal axial length, by lower values, to the axial depth of the housing of the casing, having a perforated bottom at the level of the first axial end of the part, and having at least one circumferential wall forming a perforated envelope substantially conforming to the envelope of the housing of the casing so as to be able to be placed in said housing;

c) a second axial section, extending in the axial direction in an extension of the first axial section on the side opposite the first axial end of the part and as far as the second axial end of the part, and having at least one circumferential wall forming a non-perforated envelope which axially extends the perforated envelope of the first section;

d) a first connection zone, at an axial position between the first axial section and the second axial section of the part, and having first connecting means cooperating with complementary connecting means of the casing at the level of the opening of the housing of the casing, for the leaktight fastening of the part to the casing; and,

e) a second connection zone, at the level of the second axial end of the part, and having second connection means for the leaktight fastening of a cap capable of ensuring the leaktight sealing of the part.

Thanks to the invention, it is possible to use a filter cartridge of greater axial length than a standard filter cartridge for which the axial depth of the housing has been provided in the casing, and this without having to modify the casing.

Embodiments taken alone or in combination further provide that:
the circumferential wall of the first section may comprise a first external annular groove, extending circumferentially around the first section in a plane perpendicular to the longitudinal axis which is adjacent to the first axial end of said first section, as well as a first annular seal extending in said first annular groove and adapted to provide sealing between the circumferential wall of the first section of the part and the circumferential wall of the housing when the part is mounted in the housing;
the circumferential wall of the first section may comprise a second external annular groove extending circumferentially around the first section in a plane perpendicular to the longitudinal axis which is adjacent to the first connection zone of the part, on the side of the first axial end of the first section of the part with respect to said connection zone, as well as a second annular seal extending in said annular groove and able to ensure sealing between the circumferential wall of the first section of the part and the circumferential wall of the housing when the part is inserted into the housing by its first distal end;
the housing of the casing being cylindrical in shape and the connecting means of the casing at the level of the opening of the housing of the casing comprising an inner thread provided for fastening by screwing a sealing cap of the housing, the first connecting means of the part may comprise a thread complementary to said inner thread;
the second connecting means of the part may comprise a thread identical to the inner thread of the casing at the opening of the housing of the casing;
the part may comprise active heating elements suitable for, when the part is mounted in the housing of the casing, heating the fluid in the part and/or in the housing of the casing; and,
the second section may comprise at least one deformable portion towards the outside of the part which are adapted to, when the part is mounted in the housing of the casing, compensate for an increase in the volume of fluid in the part and/or in the housing of the casing due to the freezing of said fluid.

In a second aspect, the invention also relates to an assembly comprising:

a) a liquid additive dosing module for a motor vehicle exhaust gas treatment device having a casing with a housing which is adapted to receive a removable filter cartridge and having an inlet for inserting the filter cartridge as well as a bottom opposite said inlet along the direction of an axis for inserting the filter cartridge into the housing, and which has a specific length, along said direction, between said inlet and said bottom by having circumferential walls extending substantially parallel to said direction and forming an envelope of a specific shape; as well as

b) an extension part according to the first aspect above, adapted to axially extend the housing of the casing so as to allow the use of another filter cartridge of larger axial dimensions than the first filter cartridge.

In a third aspect, the invention also relates to a device for treating the exhaust gases of a motor vehicle comprising an assembly according to the second aspect.

### DESCRIPTION OF THE DRAWINGS

Further features and advantages of the invention will become clear from reading the following detailed description. This is purely illustrative and must be read in conjunction with the appended drawings, in which:

FIG. 1 is a block diagram of a motor vehicle engine with an exhaust gas treatment device for NOx reduction;

FIG. 2 is a simplified diagram of a fluid collector in which a hollow housing is provided for the arrangement of a removable filter cartridge;

FIG. 3 is a diagram of the fluid collector of FIG. 2 with a filter cartridge of standard dimensions arranged in the housing, with a cap closing the housing in a sealed manner, and with pressurised fluid;

FIG. 4 is a simplified sectional diagram of an extension part of the housing of the fluid collector of FIG. 2 according to the embodiments;

FIG. 5 is a diagram of the fluid collector of FIG. 2 with the part of FIG. 4 mounted in the housing, and with a filter cartridge of greater axial length than the filter cartridge of FIG. 3 arranged in the part;

FIG. 6 is a perspective view of an extension part according to one embodiment; and,

FIG. 7 is a longitudinal sectional view of the extension part of FIG. 6, mounted in the housing of a fluid collector adapted to receive a standard filter cartridge.

### DESCRIPTION OF THE EMBODIMENTS

In the following description of embodiments and in the figures of the appended drawings, the same or similar elements bear the same reference numerals as in the drawings.

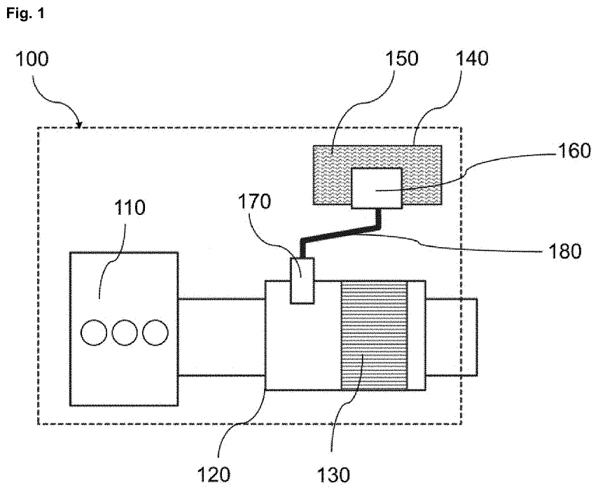

FIG. 1 schematically shows a motor vehicle 100 with an internal combustion engine 110, for example a diesel engine. The motor vehicle 100 is for example a passenger car, a utility vehicle, a lorry or a coach. The motor vehicle 100 also includes a device 120 for treating exhaust gases with a module 130 for implementing the pollution control method known as the SCR method. The vehicle 100 also comprises a reservoir 140 for the liquid additive 150, coupled to an injector 170 for introducing the liquid additive 150 into the gas treatment device 120 by means of a liquid additive metering module 160.

The metering module 160, or liquid additive dispensing device, comprises a casing in which are arranged, in particular, functional components for withdrawing the liquid additive and sending it towards the injector 170, heating it if necessary, and filtering it, as well as sensors to deliver various information on the quantity and quality of the liquid additive present in the reservoir 140. Among the elements thus arranged in the casing, there are for example: a pump for withdrawing liquid additive from the reservoir, conduits for sending the liquid additive withdrawn by the pump to the injector 170, at least one valve, various sensors such as level, pressure, temperature and/or flow sensors, an electronic control unit, at least one filter, a device for heating the liquid additive, etc.

The liquid additive can be an aqueous solution of urea at 32.5% such as the solution known under the AdBlue® brand. When the engine 110 produces exhaust gases, these gases are directed to the exhaust gas treatment device 120. The exhaust gas treatment device 120 is supplied with liquid additive 150 thanks to the liquid additive dispensing device, or metering module 160, and the injector 170. The metering module 160 meters the quantity of liquid additive to be injected. Then, thanks to the conduit 180, to which the module 160 is connected, the liquid additive is send to the injector 170. The injector 170 introduces the depolluting solution into the device 120, in order to allow the selective catalytic reduction of NOx according to the SCR method in a gas treatment zone 130 of said device 120. The exhaust gases are thus depolluted.

Advantageously, the casing of the metering module 160 is partially placed in the interior space of the reservoir 140. The part of the casing placed in the reservoir 140 offers a surface in contact with the liquid additive 150 present in the reservoir. The casing can be made of aluminium, for example, and can be coated with a non-technical polymer material such as high density ethylene polymer (HDPE), which offers the advantage of not reacting with Adblue®, which is a corrosive solution. Thus, a heating device can be connected to parts of the aluminium casing which are in contact with the liquid additive in the reservoir in order to transmit heat to the liquid additive by conduction. This makes it possible in particular to thaw the liquid additive more easily, if necessary.

As a variant, the casing can be made of HDPE. This polyethylene is the basic polymer of mechanical construction and one of the least expensive. It is an inert plastic, that is, a material which does not react chemically and/or does not deteriorate when it comes into contact with a solution of chemical agent such as a solution of urea. In addition, it is easy to handle and cold-resistant.

Alternatively, again, the casing can also be made of a technical polymer material, such as for example a polyoxymethylene (POM), polyamide, polyimide or a mixture thereof. Such a technical material has better mechanical properties that allow the creation of interfaces of complex shapes on the body of the casing with a relatively low tolerance, that is, dimensional uncertainty, for example of the order of ±0.05 millimetres (mm).

In all cases, the liquid additive reservoir and the casing of the metering module advantageously form a compact assembly, thus saving space in the motor vehicle. In the configuration as shown in FIG. 1, for example, the casing does not protrude outward from the reservoir 140.

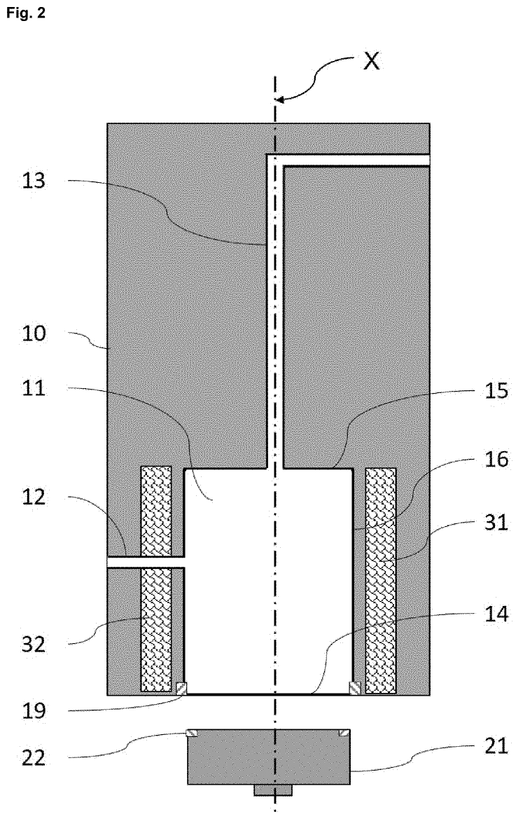

FIG. 2 shows, in section, a portion of the casing 10 of a liquid additive metering module such as the module 160 of FIG. 1. This portion of the casing 10 is part of the fluid manifold. It more particularly comprises a hollow housing 11 provided in the casing to receive a filter cartridge, which may be removable. Such a filter cartridge, not shown in FIG. 2, has the function of, and is suitable for, filtering impurities in a fluid. In the application envisaged, the fluid is Adblue® liquid additive, which is pumped into the tank 140, and which must be filtered before its injection by the injector 170 into the exhaust gas treatment device 120 of FIG. 1.

For the purposes of the present description, the filter cartridge concerned will be considered to be a standard cartridge, that is, a cartridge of standard dimensions.

Referring to FIG. 2, the housing 11 extends along a specific longitudinal axis X, between a first axial end and a second opposite axial end. It has an opening 14 at the first axial end for inserting the standard filter cartridge (not shown in FIG. 2). The filter cartridge is inserted into the housing 11 via the opening 14 in parallel to the direction of the longitudinal axis X of the housing. The housing 11 also has a bottom 15 at the second axial end. In what follows and unless expressly stated otherwise, the terms “front”, “rear”, “in front of”, “behind” and “depth” are used in reference to the direction of insertion into the housing according to the direction of the longitudinal axis X, from the opening 14 towards the bottom 15 of the housing 11.

The housing 11 has a specific axial depth. Axial depth means a depth along the direction of the longitudinal axis X. This axial depth can be measured, for example, between the opening 14 and the bottom 15 of the housing 11.

Furthermore, the housing 11 has at least one circumferential wall 16. Circumferential wall means a wall extending substantially parallel to the direction of the longitudinal axis X, around said axis, and forming the envelope of the housing 11. This envelope has a specific shape, for example the shape of a cylinder. In other words, the section of the envelope of the housing 11 is, according to this example, a circle. In other examples, it can be a polygon, when the housing has several flat walls, adjacent in pairs, and extending parallel to the direction of the longitudinal axis X. Envelopes of more complex shapes are obviously possible, depending on the needs of the application. However, a cylindrical envelope is the most general case because the filter cartridges intended to be placed in the housing are generally cylindrical.

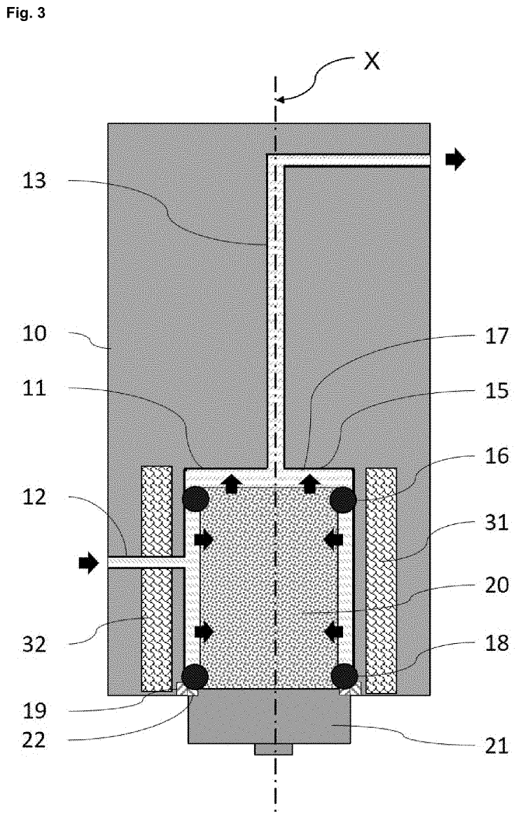

The housing 11 has a connection zone at the opening 14, in which zone connecting means 19 are provided for a sealed connection with a cap 21 for closing the housing. In the example shown of a housing of cylindrical shape, the connecting means 19 of the housing 11 comprise an inner thread, adapted to cooperate with complementary connecting means of the cap 21 comprising a thread 22. The tightness of the closure of the housing 11 by the cap 21 via these connecting means can be ensured by an O-ring 18, not shown in FIG. 2 but visible in FIG. 3, which is placed in the connection zone of the housing 11 comprising the inner thread 19, or of the end of the cap 21 comprising the thread 22, for example after insertion of the filter cartridge and before assembly of the cap. As a variant, in particular if the housing has a non-cylindrical envelope, the complementary connecting means of the housing 11 and the cap 21 can comprise bayonet connecting means, for example, or any other equivalent means within the reach of the person skilled in the art.

The fluid collector represented in FIG. 2 comprises an inlet conduit 12 leading into the housing 11 for entry of the unfiltered fluid into the housing, and a discharge conduit 13 for outlet of the filtered fluid from the housing 11. Admission of the fluid through the conduit 12, its passage through the filter cartridge in the housing 11, and its discharge through the conduit 13, are carried out by pressure difference between the admission circuit comprising the conduit 12 and the discharge circuit including the conduit 13. This pressure difference is obtained thanks to a fluid suction pump arranged upstream of the conduit 12 or downstream of the conduit 13, that is, on the side of the liquid additive tank 140 or on the side of the exhaust gas treatment device 120 of FIG. 1, respectively, with respect to the filter.

In FIG. 3, arrows illustrate the flow of fluid from the visible inlet of the inlet conduit 12 to the visible outlet of the discharge conduit 13, through a standard filter cartridge 20 when it is in place in the housing 11 and said housing is closed by the cap 21. As can be seen in the figure, an O-ring 16 is placed slightly in front of the bottom 15 of the housing 11 of the casing, and the front end of the filter cartridge 20 rests against it. Thus, a discharge chamber 17 is formed between said front end of the standard filter cartridge 20 and the bottom 15 of the housing 11, in which filtered fluid exits through the front of the filter cartridge 20. The discharge conduit 13 evacuates the filtered fluid from said chamber 17. In addition, the O-ring 18 already mentioned above with reference to FIG. 2 is placed at the level of the connection zone of the housing 11 with the inner thread 19, against which the front end of the cap 21 rests when the thread 22 engages with the inner thread 19. Thus, an intake chamber 17a is created between the cylindrical body of the filter cartridge and the envelope of the housing 11. The inlet conduit 12 opens into said chamber 17a. The fluid enters the filter cartridge 20 through its circumferential envelope and comes out filtered through the aforementioned front end of said cartridge 20.

Finally, the casing 10 comprises heating means 31 and 32 arranged around the housing 11, in the body of the casing, which are adapted to selectively heat the fluid in said housing, for example when the temperature of the fluid or a surrounding temperature is measured below a certain threshold. These heating means can be heating resistors, for example. In particular, they make it possible to thaw the AdBlue® liquid additive when it is frozen.

The compactness sought for the assembly formed by the liquid additive tank 140 and the metering module 160, which has already been mentioned above with reference to the diagram of FIG. 1, leads to designing a metering module with minimum dimensions, that is, just sufficient to meet the needs of standard applications. This concerns in particular the housing 11 provided in the casing 10 of the dosing module to receive the standard filter cartridge 20.

However, certain applications require the use of a filter having, for example, better dust-holding capacity and/or a lower pressure drop. Obtaining such improved characteristics may require the use of a larger filter cartridge than a cartridge of standard dimensions for which a metering module may have been designed. In such a case, a person skilled in the art who does not benefit from the teaching of the invention will have to modify the design of the casing in order to provide a larger housing capable of receiving a filter cartridge of larger dimensions.

In order to allow the use of another filter cartridge of larger dimensions than those of the standard filter cartridge for which the housing 11 in the casing 10 of FIG. 2 has been designed, embodiments of the invention propose the use of a housing 11 extension part. This is more particularly an axial extension of the housing 11, that is, an extension along the direction of the longitudinal axis X. This extension makes it possible to enlarge the axial depth (in the aforementioned sense) of the space intended to receive the other filter cartridge beyond the distance between the opening 14 and the bottom 15 of the housing 11. In this sense, the extension part is an adapter because it allows adapting a filter cartridge of larger axial dimensions for use in the housing 11 of smaller axial dimensions.

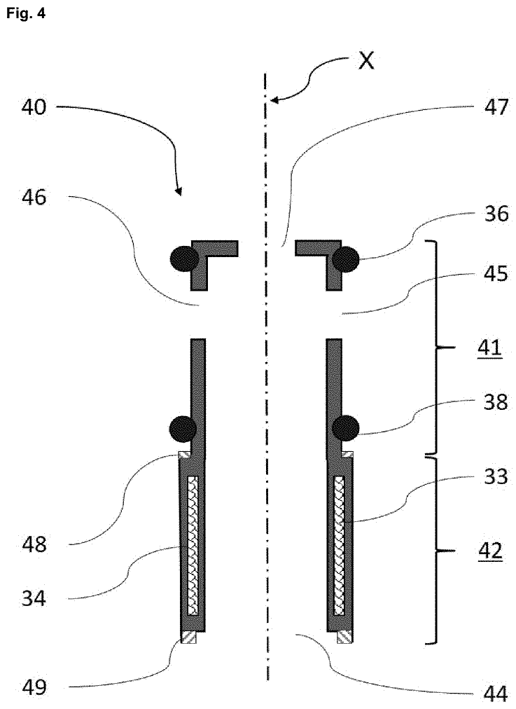

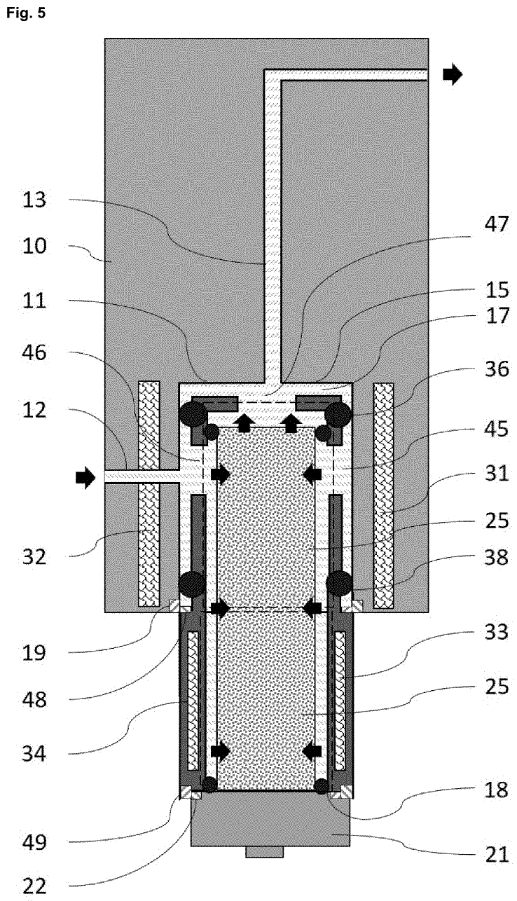

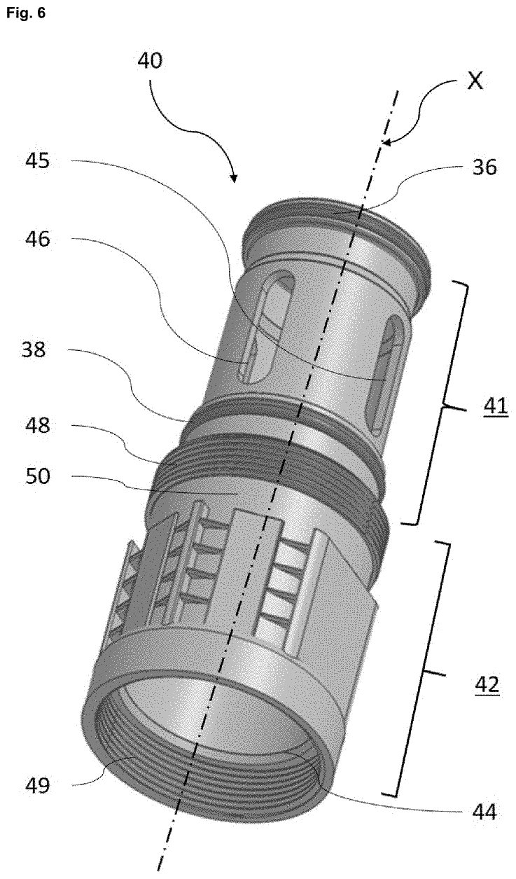

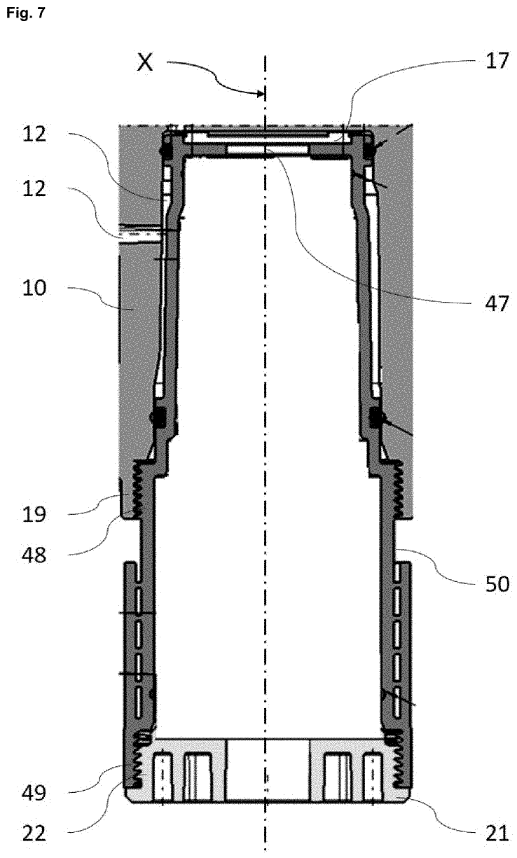

The simplified diagrams of FIG. 4 and FIG. 5 show respectively, in section, the extension part 40 alone and said extension part 40 in the housing 11 of the casing 10 of FIG. 2. Furthermore, in the configuration of FIG. 5, the larger filter cartridge 25 is fitted into the adapter 40. FIG. 6 shows a three-dimensional view, in perspective, of an embodiment of the extension part 40, and FIG. 7 shows a sectional view of the part 40 of FIG. 6 and of the housing 11 in the casing 10. In these figures, the same elements as those already described with reference to FIGS. 2 and 3 bear the same references and their description will not be repeated.

The extension part 40 is a hollow part adapted to receive the larger filter cartridge 25. The extension part 40 has a longitudinal axis, which coincides with the longitudinal axis X of the housing 11 in the casing 10 when the part 4 is mounted in said housing. For the sake of simplicity, reference will be made to the longitudinal axis X to designate both the longitudinal axis of the housing 11 of the casing 10 on the one hand, and the longitudinal axis of the part 40, on the other hand.

Part 40 comprises a first axial end through which the part can be inserted into the housing 11 of the casing 10, called the “front end” in what follows. It also comprises a second axial end, opposite the front end, and called the “rear end” in what follows. Part 40 is provided with an opening 44 at its rear end, through which the filter cartridge 25 can be inserted into the part 40 even when the latter is engaged in the housing 11 by its front end.

As shown in particular in FIGS. 4 and 6, the part 40 comprises two axial sections 41 and 42, which extend along the axial extension of one another.

On the side of the front end, the part thus comprises a first axial section 41, or front section, of axial length substantially equal, by lower values, to the axial depth of the housing 11 of the casing 10. The front section 41 has a perforated bottom, to produce an opening 47 at the front end of the part 40. The front section 41 has at least one circumferential wall forming an envelope substantially conforming to the envelope of the housing 11 of the casing so as to be able to be placed in said housing 11. This envelope is perforated, due to the presence of side openings 45 and 46. Preferably, the openings 45 and 46 extend parallel to the direction of the longitudinal axis X and have a length substantially equal to the axial length of the front section 41, in order to offer the greatest possible passage to the fluid without too much of an effect the rigidity of the part 40.

On the side of the rear end, the part 40 further comprises a second axial section 42, or rear section. This section extends in the axial direction along the extension of the first front section 41, on the side opposite the front end of part 40, and as far as the rear end of the part 40. The rear section 42 has at least one circumferential wall forming a non-perforated envelope, which axially extends the perforated envelope of the front section 41. When the front section 41 is completely inserted into the housing 11 of the casing 10, as shown in FIG. 5 and in FIG. 7, the rear section 42 projects axially outside of said casing 10, in the opposite direction to the bottom 15 of the housing 11 of the casing 10.

Sections 41 and 42 are delimited between them, axially, by a first connection zone comprising means for connecting the part 40 to the casing 10. These connection means comprise for example a thread 48 of the part 40 able to cooperate with the inner thread 19 of the casing 10 at the level of the opening 14 of the housing 11 of the casing 10. In other words, the means for connecting the part 40 to the casing 10 are arranged at an axial position substantially corresponding to the junction between the first axial section 41 and the second axial section 42 of part 40. The above-mentioned connecting means 48, 19 are capable of producing a sealed fastening of the part 40 to the casing 10. To obtain this tightness, the connecting means can include and cooperate with a seal 38. In the example shown, the seal 38 is an annular seal, for example an O-ring.

In other words, and assuming that the housing 11 of the casing is cylindrical in shape, the means for connecting the part 40 to the casing 10, provided at the level of the opening 14 of the housing 11 of the casing 10, comprise the inner thread 19 in the casing 10 which is provided for fastening by screwing the sealing cap 21 of the housing 11 when a standard filter cartridge 20 is used (FIG. 3), on the one hand, as well as the first connecting means of the part 40 comprising the thread 48 which is complementary to said inner thread 19, on the other hand.

The part 40 comprises a second connection zone, at the level of the rear end of the part, with second connecting means for the leaktight fastening of a cap capable of ensuring the leaktight sealing of the part. The cap can advantageously be the cap 21 used to close the housing 11 of the casing 10 when it contains the standard filter cartridge 20, or an identical cap also comprising a thread 22. Whereby the connecting means of the cap 21 comprise, on the one hand, the thread 22 of the cap 21 and, on the other hand, a second connecting means of the part 40 comprising an inner thread 49 complementary to the thread 22 at the rear end of the part 40. The inner thread 49 is preferably identical to the inner thread 19 of the casing 10 at the opening 14 of the housing 11 of the casing 10, to allow reusing the cap 21. The tightness of this connection between the part 40 and the cap 21 can be ensured by an annular seal, for example an O-ring, such as for example the seal 18 already described above with reference to the diagram of FIG. 3, or an identical or similar seal.

In other words, and still assuming that the housing 11 of the casing is cylindrical, the second connecting means of the part 40 comprise, at the rear end of the part, an inner thread 49 identical to the inner thread 19 of the casing 10 at the level of the opening 14 of the housing 11 of the casing 10. This allows reusing the same cap 21 as that provided for uses in which a standard filter cartridge is used, if necessary with the same seal 18.

In one embodiment, the circumferential wall of the first section 41 comprises a first external annular groove (that is, open on the side of the wall opposite to the longitudinal axis X), extending circumferentially around the first section in a plane perpendicular to the longitudinal axis which is adjacent to the front end of said first section, as well as a first annular seal 36 extending along said first annular groove. This seal 36, for example an O-ring as shown, is able to provide sealing between the circumferential wall of the first section 41 of the part 40 and the circumferential wall 16 of the housing 11, substantially at the bottom 15 of the housing, when the part 40 is mounted in the housing with the section 41 fully housed in the housing 11.

In another embodiment, the circumferential wall of the first section 41 may also comprise a second outer annular groove (that is, open on the side of the wall which is opposite to the longitudinal axis X), extending circumferentially around the first section 41 in a plane perpendicular to the longitudinal axis which is adjacent to the first connection zone (i.e., the connection zone with the thread 48) of the part 40, on the side of the rear end of the first section 41 of said part 40 with respect to said connection zone, as well as the annular seal 38 (already presented above) extending along said annular groove. Thus arranged, the seal 38, for example an O-ring as shown, is able to provide sealing between the circumferential wall of the first section of the part and the circumferential wall of the housing 11, substantially at the opening 14 of the housing, when the part 40 is mounted in the housing with section 41 fully housed in the housing 11.

Referring to the simplified diagram of FIG. 5, the flow of fluid in the collector is as follows when the larger cartridge 25 is used in combination with the extension part or adapter 40. As shown by the arrows in FIG. 5, the fluid is admitted into the housing 11 and enters the part 40 via the side openings 45, 46 made in the front section 41. It is prevented from passing directly into the discharge chamber 17, due to the O-ring 36. Under the effect of the pressure, it then passes through the circumferential envelope of the filter cartridge 25, and this not only at the level of the front section 41 but also at the level of the rear section 42 of the part 40. As a result, the exchange surface between the fluid and the envelope of the filter cartridge 25 is increased compared to the use of the standard filter cartridge 20 of FIG. 3. As a result, in particular, the pressure drop due to the filter can be reduced, and/or it can be compensated or limited even when the filter cartridge 25 comprises smaller pores than the pores of the standard cartridge 20 in order to provide better dust-holding capacity. The fluid then leaves the filter cartridge 25 at the front end of the part 40, towards the bottom 15 of the housing 11 of the casing 10.

In some embodiments, the part 40 can comprise active heating elements 33 and 34, arranged for example in the walls of the second section 42. These means 33 and 34, visible in FIG. 5, are adapted to heat the fluid in part 40 and/or in the housing 11 when the part 40 is mounted in the housing 11 of the casing 10. This is particularly useful because, since the second section 42 of the part 40 projects outwards from the casing 10, the risk of the Adblue® liquid additive freezing in winter is increased compared to the use of the standard filter cartridge 20 (FIG. 3). These elements 33 and 34 can be controlled by the same means as those which control the heating elements 31 and 32 of the casing 10. For this purpose, connecting wires (not shown) can connect the part 40 to a connector (not shown) of the casing 10.

In another embodiment, the rear section 42 of the part 40 can comprise portions 50 that can be deformed towards the outside of the part 40 (that is, away from the longitudinal axis X). Such portions 50 are suitable for, when the part 40 is mounted in the housing 11 of the casing 10, compensating for any increase in the volume of fluid in the part 4 and/or in the housing 11 due to the freezing of said fluid. To this end, the portions 50 may have less thickness, and/or not have ribbed reinforcements unlike the other portions of the rear section 42 of the part 40, visible for example in FIG. 6 and in FIG. 7, between the deformable portion 50 and the opening 44 at the rear end of the part 40.

As has been understood, the extension part 40 makes it possible to use a filter cartridge 25 of larger axial dimensions than the standard filter cartridge 20, while retaining the casing 10 with the housing 11, the axial depth of which has been designed to receive a standard filter cartridge 20. The larger filter cartridge 25 can be inserted into the extension part 40 when said part is mounted in the housing 11 of the casing 10. It is enclosed therein in a leakproof manner when the sealing cap 21 is put in place to close the opening 44 at the rear end of the part 40.

The part 40 can be made of aluminium, for strength, and then be covered with high density ethylene polymer (HDPE). Alternatively, it can be made of HDPE. It can also be made of polyoxymethylene (POM), polyamide, polyimide or a mixture thereof.

The present invention has been described and illustrated in this detailed description and in the figures of the accompanying drawings, in possible embodiments. The present invention is not, however, limited to the embodiments shown. Other variants and embodiments can be deduced and implemented by those skilled in the art on reading this description and the appended drawings.

In this disclosure, the term “comprising” or “including” does not exclude other elements or other steps. The various characteristics presented can be advantageously combined. Their presence in different parts of this patent application does not exclude this possibility. The references to the drawings cannot be understood as limiting the scope of the invention.

1. An extension part of a hollow housing provided in a casing to receive a first filter cartridge, said housing extending along a longitudinal axis determined between a first axial end and a second opposite axial end, and having an opening at the first axial end for inserting said first filter cartridge into the housing parallel to the direction of the longitudinal axis of the housing, and a bottom at the second axial end, said housing having a specific axial depth, between said opening and said bottom, and having at least one circumferential wall extending substantially parallel to said direction and forming an envelope of a specific shape, said extension part having a longitudinal axis and comprising:
a) a first axial end through which the part can be inserted into the housing of the casing, and a second axial end provided with an opening through which a second filter cartridge, of greater axial length than the axial depth of the housing, can be inserted and sealed in the part when said part is mounted in the housing of the casing;
b) a first axial section of axial length substantially equal, by lower values, to the axial depth of the housing of the casing, having a perforated bottom at the level of the first axial end of the part, and having at least one circumferential wall forming a perforated envelope substantially conforming to the envelope of the housing of the casing so as to be able to be placed in said housing;
c) a second axial section, extending in the axial direction along the extension of the first axial section on the side opposite the first axial end of the part and as far as the second axial end of the part, and having at least one circumferential wall forming a non-perforated envelope which axially extends the perforated envelope of the first section;
d) a first connection zone, at an axial position between the first axial section and the second axial section of the part, and having a first connecting means cooperating with complementary connecting means of the casing at the level of the opening of the housing of the casing, for the sealed attachment of the part to the casing; and,
e) a second connection zone, at the level of the second axial end of the part, and having a second connecting means for the leaktight fixing of a cap capable of ensuring the leaktight sealing of the part.

2. The extension part according to claim 1, wherein the circumferential wall of the first section comprises a first external annular groove, extending circumferentially around the first section in a plane perpendicular to the longitudinal axis adjacent to the first axial end of the said first section, as well as a first annular seal extending along said first annular groove and able to provide sealing between the circumferential wall of the first section of the part and the circumferential wall of the housing when the part is mounted in the housing.

3. The extension part according to claim 1, wherein the circumferential wall of the first section comprises a second external annular groove, extending circumferentially around the first section in a plane perpendicular to the longitudinal axis which is adjacent to the first connecting zone of the part, on the side of the first axial end of the first section of the part with respect to said connecting zone, as well as a second annular seal extending along said annular groove and able to provide sealing between the circumferential wall of the first section of the part and the circumferential wall of the housing when the part is inserted into the housing by its first distal end.

4. The extension part according to claim 1, wherein, the housing of the casing being cylindrical and the means of connecting the casing at the opening of the housing of the casing comprising an inner thread provided for fixing by screwing of a sealing cap of the housing, the first means for connecting the part comprise a thread complementary to said inner thread.

5. The extension part according to claim 4, wherein the second means for connecting the part comprise an inner thread identical to the inner thread of the casing at the level of the opening of the housing of the casing.

6. The extension according to claim 1, comprising active heating elements adapted to heat the fluid in at least one of the part and in the housing of the casing when the part is mounted in the housing of the casing.

7. The extension according to claim 1, wherein the second section comprises at least one portion deformable towards the outside of the part which are adapted to, when the part is mounted in the housing of the casing, compensate for an increase in the volume of fluid in at least one of the part and in the housing of the casing due to the freezing of said fluid.

8. An assembly including:
a) a module for dosing liquid additive for a motor vehicle exhaust gas treatment device having a casing with a housing adapted to receive a removable filter cartridge and having an inlet for inserting the filter cartridge as well as a bottom opposite said inlet along the direction of an axis for inserting the filter cartridge into the housing, and having a specific length, in said direction, between said inlet and said bottom, and having circumferential walls extending substantially parallel to said direction and forming an envelope of a specific shape; and,
b) an extension part according to any one of the preceding claims, adapted to axially extend the housing of the casing so as to allow the use of another filter cartridge of greater axial dimensions than the first filter cartridge.

9. A device for treating the exhaust gases of a motor vehicle comprising an assembly according to claim 8.
